(19) United States
(12) Patent Application Publication
(10) Pub. No.: US 2014/0195168 A1
(43) Pub. Date: Jul. 10, 2014

(54) CONSTRUCTING A DIFFERENTIAL DIAGNOSIS AND DISEASE RANKING IN A LIST OF DIFFERENTIAL DIAGNOSIS

(71) Applicant: Yahya Shaikh, Venice, CA (US)

(72) Inventor: Yahya Shaikh, Venice, CA (US)

(21) Appl. No.: 14/148,001

(22) Filed: Jan. 6, 2014

Related U.S. Application Data
(60) Provisional application No. 61/754,173, filed on Jan. 18, 2013.
(60) Provisional application No. 61/749,365, filed on Jan. 6, 2013.

(51) Int. Cl. G06F 19/00

(52) U.S. Cl. CPC G06F 19/34
USPC 702/19

(57) ABSTRACT

Disclosed is a system and method for developing a differential diagnosis list or disease ranking in a list of differential diagnosis or identifying a unique disease process when the etiology of patient's presentation is unknown. In one example, the method receive one or more symptoms of a patient, determines a set of diseases having at least one clinical feature that overlaps with the patient's symptoms, determines a ratio of prevalence for each respective disease to a cumulative prevalence of the set of diseases, determines a respective relative probability score for each disease of the set of diseases in view of the ratio of prevalence, determines a ranking of the diseases of the set of diseases in view of the relative probability scores, and outputs the ranking of the diseases.

### RELATED APPLICATIONS

The present application claims the benefit of U.S. Provisional Application Ser. No. 61/749,365, titled “Computer Implemented Method and Systems for Disease Ranking in a List of Differential Diagnosis,” filed on Jan. 6, 2013, the entire contents of which are herein incorporated by reference, and claims the benefit of U.S. Provisional Application Ser. No. 61/754,173, titled “Computer Implemented Method and Systems to Construct a Differential Diagnosis,” filed on Jan. 18, 2013, the entire contents of which are herein incorporated by reference.

### TECHNICAL FIELD

The present disclosure relates generally computer implemented methods and systems for medical differential diagnosis.

### BACKGROUND

A medical symptom is often a manifestation of a disease. For example, a headache may be a manifestation of various and diverse conditions such as the flu, depression, stress, a migraine headache, a ruptured aneurysm, a brain tumor, etc. Understanding the significance of the medical symptom is important to the proper diagnosis and treatment of the underlying disease.

### BRIEF DESCRIPTION OF THE DRAWINGS

The present disclosure will be more readily understood from the detailed description of example embodiments presented below, considered in conjunction with the attached drawings, of which:

FIGS. 1A and 1B are flowcharts showing embodiments of a method for creating a differential diagnosis list;

FIGS. 2A and 2B are flowcharts showing embodiments of a method for updating a differential diagnosis list;

FIG. 3 is a flowchart showing one embodiment of a method for generating pathologic pathways for diseases in a differential diagnosis list;

FIG. 4 is a flowchart showing one embodiment of a method for rendering of pathologic pathways for diseases in a differential diagnosis list within the context of existing pathologic pathways;

FIG. 5 is a flowchart showing one embodiment of a method for calculating relative probability scores for possible diseases;

FIG. 6 is a flowchart showing one embodiment of a method for ranking diseases from a given differential diagnosis list;

FIG. 7 is a flowchart showing one embodiment of a method for constructing a differential diagnosis profiles list;

FIG. 8 is a flowchart for a method of constructing an overlapping features section of a differential diagnosis profiles list, in accordance with one embodiment;

FIG. 9 is a flowchart showing one embodiment for a method of calculating relative probability scores for diseases on a given differential diagnosis list;

FIG. 10 is a diagram showing an example of assigning relative probability scores to diseases, in accordance with one embodiment; and

FIG. 11 is a block diagram of a computer system that may perform one or more of the operations described herein.

### DETAILED DESCRIPTION

Embodiments of the present disclosure are directed to a system and method for constructing a differential diagnosis and disease ranking in a list of differential diagnosis.

In some embodiments, the present disclosure comprises computer implemented methods and systems that approximate a likely cause of a patient's condition if a disease is not known (e.g., if the disease is not included in a database of knowledge accessible to the systems). It is noted that the term “patient” is used herein to refer to a person who receives a health care service from a health care professional. A differential diagnosis list (DDL) can be continuously updated as new information is made available. As used herein, the term “differential diagnosis list (DDL)” shall generally mean a list or collection of data stored in a database that may include different disease names such as hyperthyroidism, pneumonia, gastro esophageal reflux disease, urinary tract infection, etc., the disease names representing a likely explanation for a user's presentation.

The method can communicate the rationale to a user behind the selection of likely disease conditions to physicians and others who are familiar with medical diagnosis and management. As used herein, the term “user” shall generally mean a person accessing the system as described herein through a client device. In some embodiments, a user may be a doctor, a health care provider, a member of a medical staff, or the patient. As used herein, the term “user information” or “user clinical information” shall generally mean information relevant to the user's health and conditions such as age, ethnicity, gender, history of present illness, past medical history, medication use history, surgical history, social history, history of allergies, family history, social history, information from their medical records, symptoms, signs, laboratory findings, imaging findings, and genome studies. Furthermore, this method can direct an investigation of disease entities which have not yet been defined by prior knowledge.

In some further embodiments, the present disclosure comprises computer implemented methods and systems that assigns probability ranks to diseases in a list of possible differential diagnosis, such as that used by physicians or diagnostic software. In some further embodiments, the rank assigned to a disease is calculated from a dependent probability of that disease, given the symptom combination for which that disease was included on a DDL. As used herein, the term “symptom” is used very generally to refer to any clinical information including but not restricted to user reported observations regarding their health, physician elicited signs and physical exam findings, measurable parameters such as vitals and lab values, and the results of tests such as imaging and genome studies. The method can enhance the relevance of results from diagnostic software where the possible list of diseases is often large and the order of output and results may be unrelated to the probability of disease in the patient.

In another example where etiology of patient's presentation is unknown, the method receives one or more symptoms of a patient, calculates a Relative Probability Score based on the related disease prevalence and the symptom combinations that overlap between that element and the user's presentation to direct further information gathering, collects further information based on paths of disease progression and processes, and outputs a construction of disease pathways to convey information to clinicians and to direct lines of inquiry.

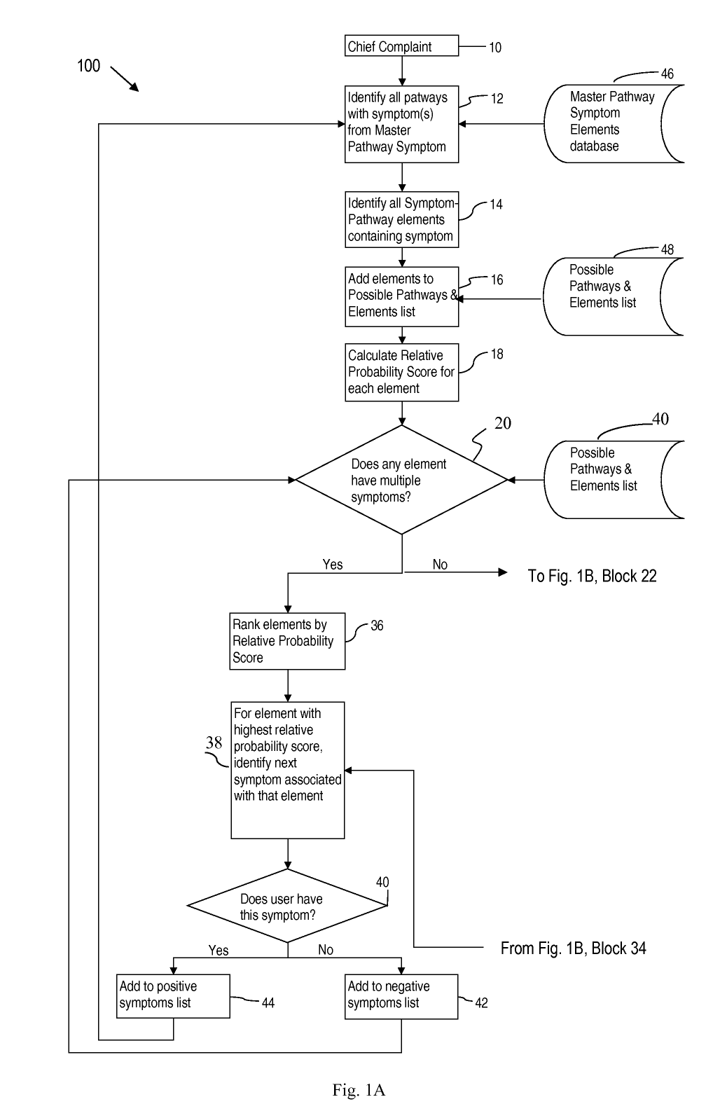

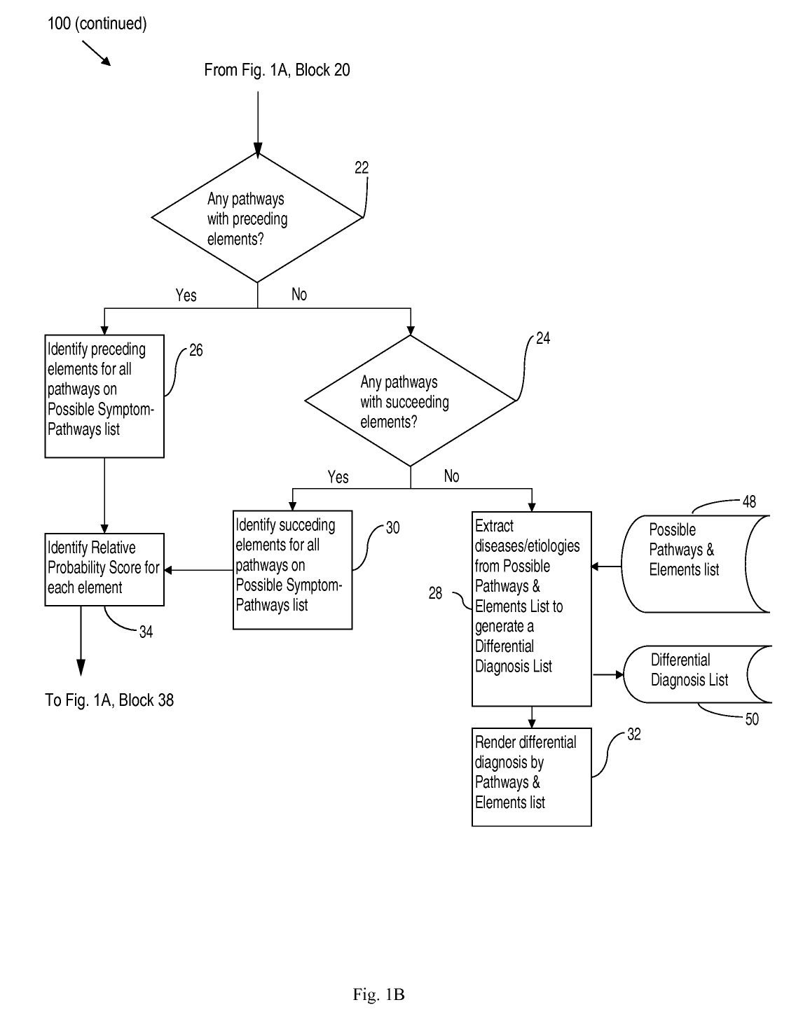

Referring now to the disclosure in more detail, FIGS. 1A and 1B illustrate embodiments of a method 100 for building a DDL using pathologic and physiologic mechanisms. The DDL leads to identification of a symptom preceding with prior causes and associated symptoms along one or more disease pathways. At least some operations of method 100 may be performed by processing logic that may comprise hardware (circuitry, dedicated logic, etc.), software (such may be executed on a general-purpose computing system or a dedicated machine), or a combination of both. At block 10 of method 100, a patient's symptoms (e.g., the chief complaint) are first gathered through any combination of a number of means including user-healthcare worker interviews, user/computer interactions, third party entry or any other means. After the symptoms are gathered, at block 12 the processing logic identifies disease pathways within which those symptoms appear. As used herein, the term “disease pathway” or “pathologic pathway” shall generally mean the mechanisms through which disease can occur in a person, which incorporates the cause/effect models of maintaining normal human physiology and function and includes the aberrancies that can occur in a step-wise manner.

In one embodiment, the processing logic queries a data store (e.g., a master pathway symptom elements database) for the disease pathways, and receives data 46 associated with the disease pathways from the queried data store. As used herein, the term “master pathway symptom elements database” shall generally mean a collection of data stored on a computer and may include data such as disease name, risk factors, prevalence in the general population, prevalence in populations with risk factors, symptoms, signs, physical exam findings, laboratory values, imaging findings, and genetic findings.

At block 14, the processing logic identifies from the identified disease pathways a causal or etiologic element for which the user's symptoms are the effect. At block 16, the processing logic adds the identified disease pathways and the causal elements associated with the user's symptoms in those pathways to a list. The list may be possible pathways & elements list 48. As used herein, the term “possible pathways & elements list” shall generally mean a list or collection of data stored in a database and includes the disease pathways and pathway elements related to the differential diagnosis of the user or patient.

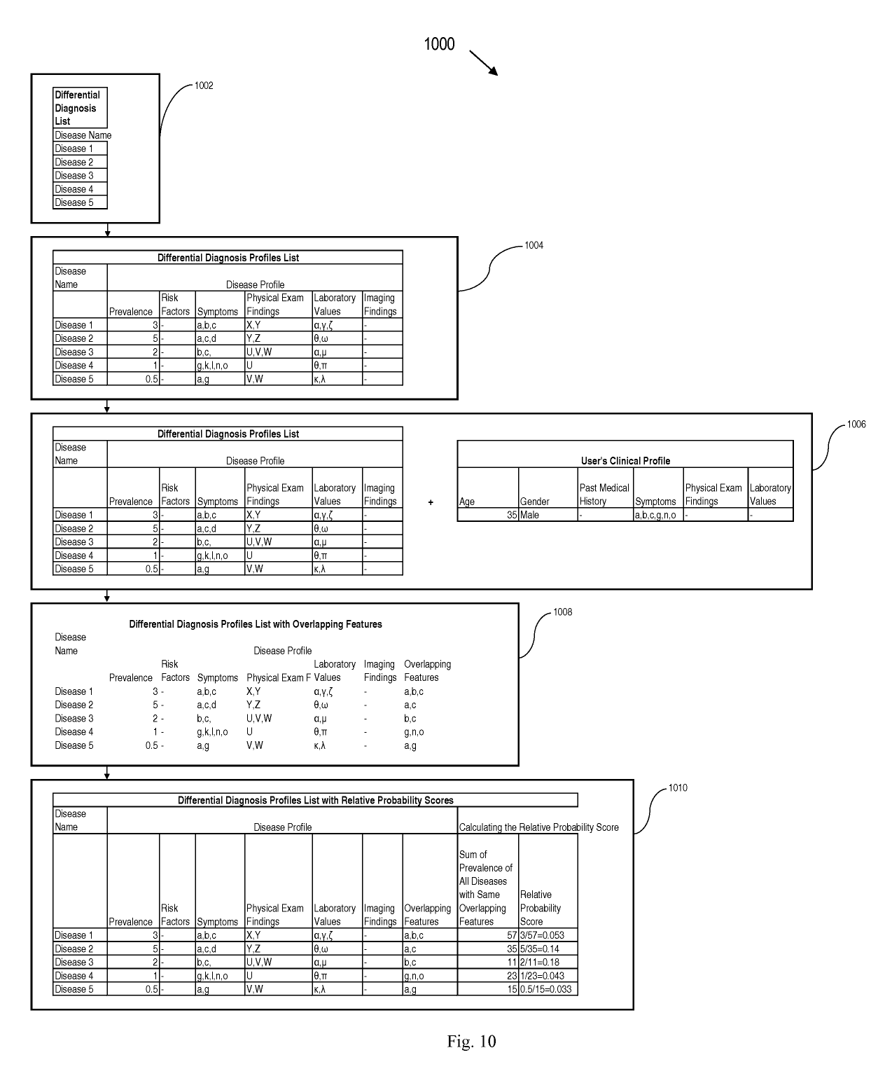

Having generated a list of possible mechanisms for disease, at block 18 the processing logic calculates a relative probability score for each disease pathway. As used herein, the term “relative probability score” shall generally mean a number or value representing (but not necessarily equivalent to) the conditional probability of some entity given the presence of other entities. In one embodiment, for the relative probability score, the individual probabilities may be determined, but not the probability of any of the combinations. An example of how the relative probability score may be calculated is described in further detail below with respect to FIG. 10.

In another embodiment, the term “disease relative probability score” shall generally mean a number or value representing (but not necessarily equivalent to) the conditional probability of a disease diagnosis given the user's clinical features. Disease prevalence data is used to represent the prevalence of any factor related to that disease or related to the mechanisms that cause that disease. In the context of this method the “disease relative probability score” can be used to approximate the probability of an element being the cause of a symptom or a combination of symptoms with which it is associated and which the user has. In one embodiment, the prevalence of the symptom within a disease is assumed to be equivalent to the prevalence of the disease to which it belongs. In one embodiment, the prevalence of a disease may be in view of either a time period (e.g., a certain disease may be widespread at a particular time period), a specific population (e.g., the disease may be common to a certain group or population), or a geographic location (e.g., the disease may be likely to occur in a certain geographic region). The shortened term “relative probability score” may also be used herein to refer to a disease relative probability score in some instances.

In one embodiment, a prevalence ratio is calculated for a specific disease among a set of diseases. The prevalence ratio can be calculated by dividing the prevalence of the specific disease by a cumulative prevalence of the set of diseases. For example, if the prevalence of a specific disease is 10, and the cumulative prevalence of the set of diseases (including the specific disease) is 100, then the prevalence ratio is 0.10 for the specific disease.

There are a number of assumptions which are desired to calculate the “relative probability score,” but which may not be accurate if an absolute score number is used to represent diseases. Some of these assumptions include: the assumption that each symptom or component within a disease pathway is independent of other symptoms or components (whereas in reality symptoms and components may be related to one another with varying strengths); and the prevalence of a symptom or component of a disease pathway is considered to be equivalent to that of the disease itself (this may not be true because the association between a disease and its components or symptoms is rarely 100%). These assumptions, though, may be applied to all diseases and are expected to generate a systematic error which will decrease the value of any score similarly. Accordingly, in one embodiment there is no value to saying that one relative probability score is twice as great as another. Because a systematic error is applied in some embodiments, a ranking can be used to make the relative probability score meaningful to distinguish the conditional probability of diseases from each other given a set of conditions.

Notably, the assumption of a systematic error is not necessarily applicable to all diseases because while it is expected to affect all diseases, it may do so with varying degrees. However, this effect would approach a normal statistical distribution given sufficient number of conditions. In the case of this method the relative probability score is used to approximate the conditional probability of an element given a combination of symptoms. The prevalence of each combination of symptoms present in an element is assigned the prevalence value for the disease. In some embodiments a relative probability score can be calculated by a rules engine using a set of rules or formulas.

In one embodiment, an element relative probability score is associated with each causal or etiologic element. The element relative probability scores are computed in order to approximate the conditional probability of a disease pathway given the causal elements and symptoms. This then helps to better direct further investigation by examining each causal element to determine the next step in investigation.

At block 20, the processing logic determines whether the generated list includes any causal elements that have multiple symptoms. As used herein, the term “causal element” or “etiologic element” refers to a single distinct component (typically a cause-effect component) within a disease pathway. A causal element can lead to other elements (one being the cause and the other the effect) and/or can lead directly to symptoms (e.g. the element being the symptom's direct cause). Some non-limiting examples of a causal element includes: in the disease of asthma, the element of “bronchospasm” can lead to the symptoms of “wheezing” and “shortness of breath”; in the disease of pneumonia, the element of “inflammation in the alveoli” can lead to the element of “decreased gas exchange,” which is a causal element that can lead to the element of “fibrin and edema in the alveolar walls”, which is a causal element that can lead to the symptoms of “dyspnea” and “tachypnea.”

If one or more causal elements in the generated list (e.g., the possible pathways & elements list 48) have multiple symptoms associated with them, the method proceeds to block 36. Otherwise, the method proceeds to block 22 as illustrated in FIG. 1B. At block 36, the processing logic ranks the causal or etiologic elements based on their associated element relative probability scores. At block 38, the processing logic receives an identified relative probability score for each element from block 34 as illustrated in FIG. 1B, and for the element with the highest relative probability score, identifies the next symptom associated with that element. At block 40, the processing logic determines whether the user is suffering from the symptom associated with the respective causal element. Symptoms that are found in or affecting the user are added to a positive symptoms list at block 44 and those not found in or affecting the user are added to a negative symptoms list at block 42. As used herein, the term “positive symptoms list” shall generally mean a list or collection of data stored in a database and includes those symptoms found to be true for the user or patient. As used herein, the term “negative symptoms list” shall generally mean a list or collection of data stored in a database and includes those symptoms found to be not true or not applicable for the user or patient. The method then returns to block 12 if the symptom was added to the positive symptoms list and to block 20 if the symptom was added to the negative symptoms list.

At FIG. 1B, block 22, when the element does not have multiple symptoms (block 20 of FIG. 1A), the processing logic checks the disease pathways to identify any preceding causal elements. If a preceding causal element is identified, the method continues to block 26. If no preceding causal element is identified, the method proceeds to block 24.

At block 26, the processing logic identifies preceding causal elements for all pathways on the possible symptom pathways list. At block 26, the processing logic identifies preceding causal elements in all disease pathways on the possible symptom-pathways list. The method then continues to block 34.

At block 24, the processing logic checks the disease pathways to identify any succeeding causal elements. If a succeeding causal element is identified, the method continues to block 30, at which the processing logic identifies succeeding elements for all pathways on the possible symptom-pathways list, after which the method continues to block 34. If no succeeding causal elements are identified, the method continues to block 28.

At block 34, the processing logic calculates relative probability scores for each element so that the appropriate element can be used to elicit symptoms. The method then continues to block 36 of FIG. 1A.

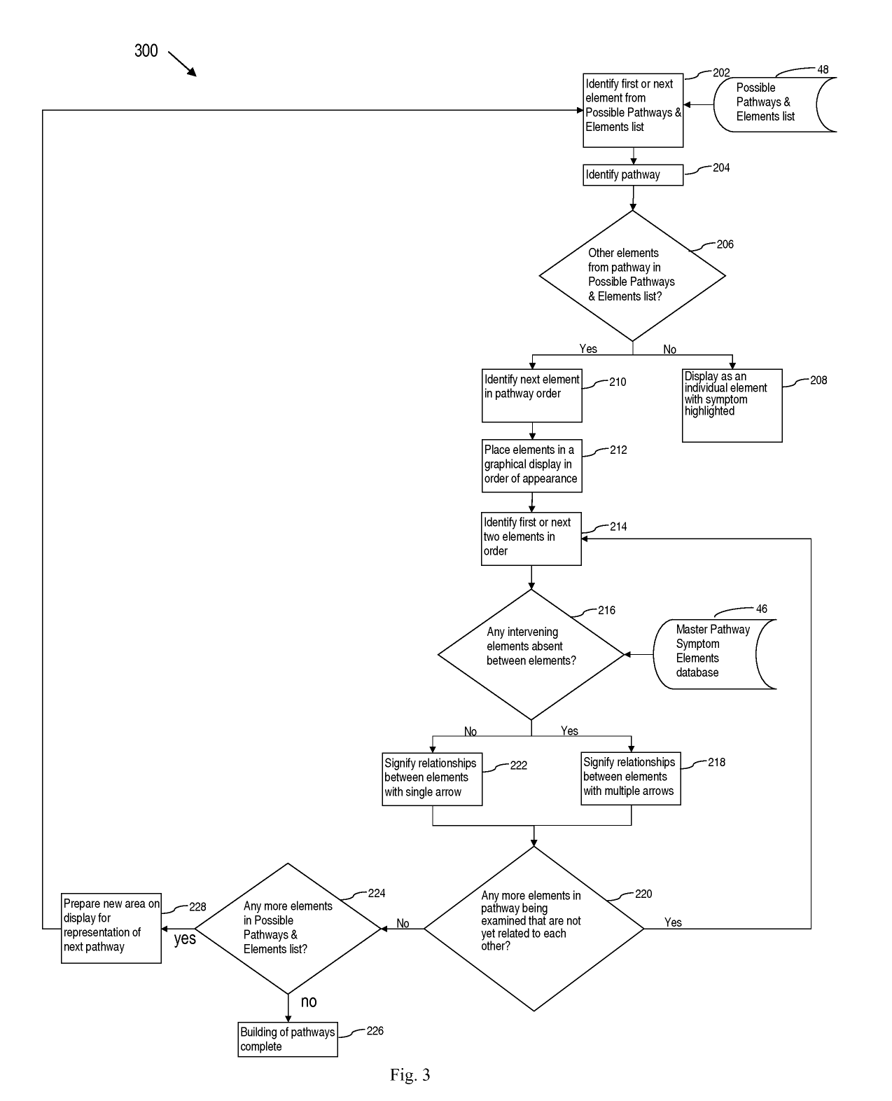

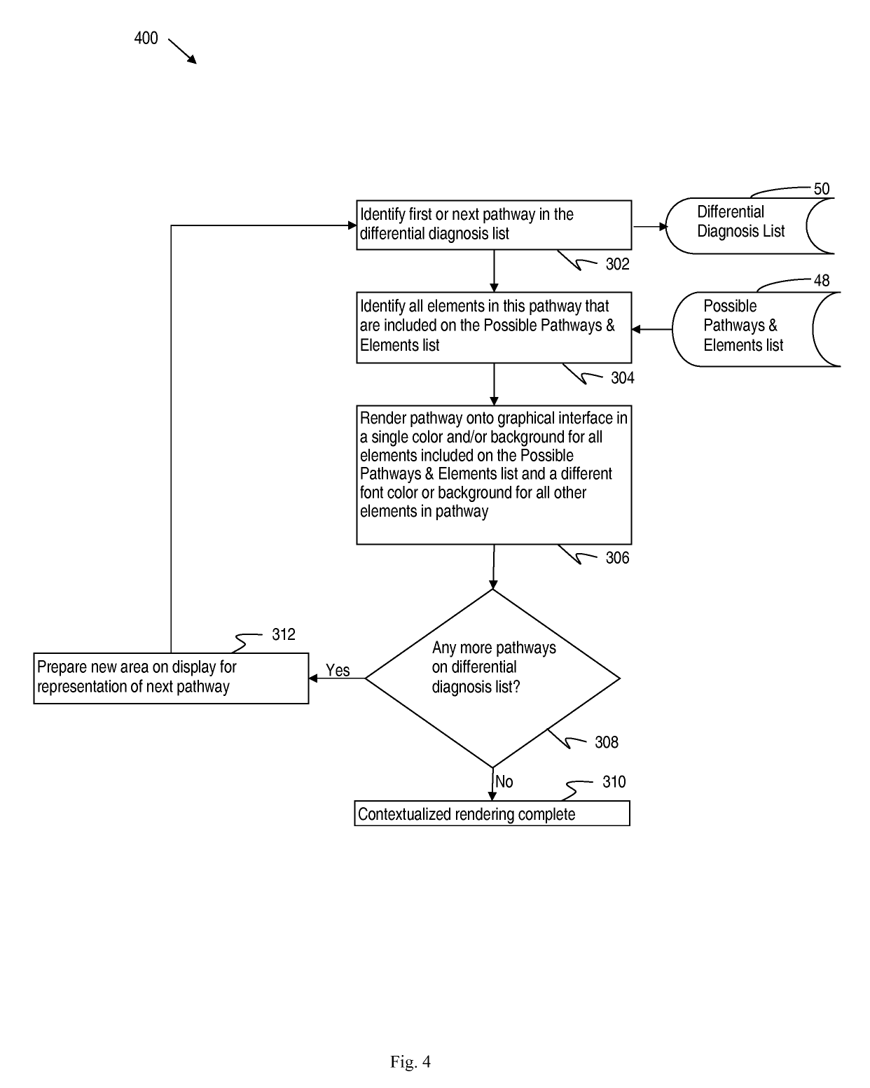

If after block 24 there are no further elements in any of the pathways or the threshold for identifying elements is reached (e.g., by the amount of information already gathered, certainty of a disease etiology, number of questions asked, etc.), then at block 28 disease pathways from the possible pathways and elements list 48 are examined to identify associated etiologic elements and diseases. As used herein, an etiologic element is a component of the disease pathway that identifies a cause or origin of the disease. The threshold can be set based on a number of factors including but not limited to diagnostic certainty for diseases already on the DDL 50, urgency of the patient's symptoms or of management decisions based on diseases already on the DDL 50, and a number of questions previously asked of the patient. The processing logic may then create a DDL 50. At block 32, the processing logic may render a differential diagnosis based on the pathways and elements list. Embodiments for generating pathological pathways for a DDL 50 are described with reference to FIG. 3 and FIG. 4.

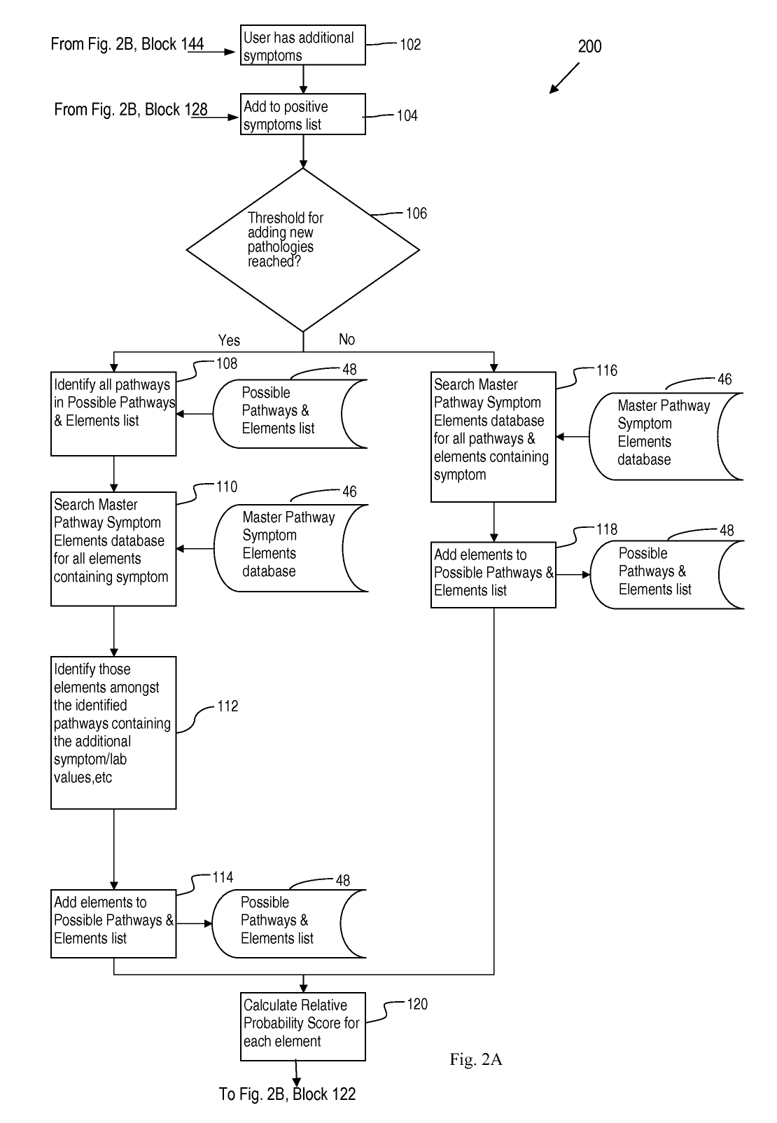

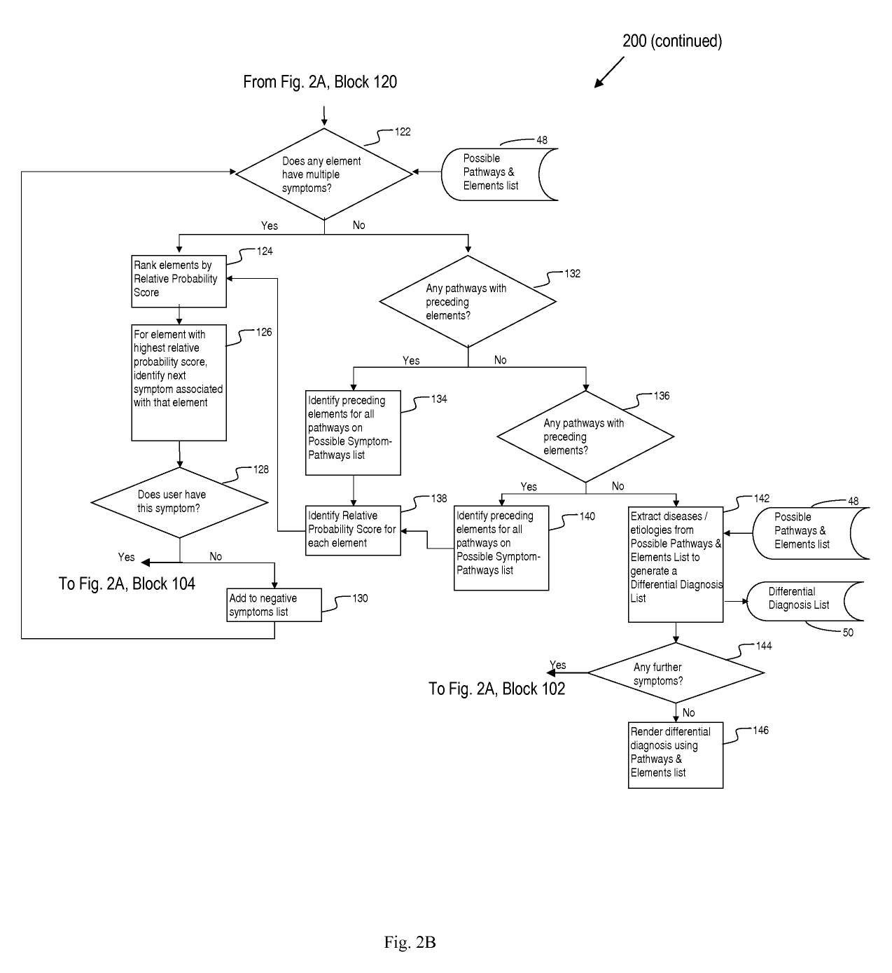

FIGS. 2A and 2B are flowcharts showing one embodiment of a method 200 for updating a DDL. Method 200 begins at block 102, at which the processing logic determines that a user has additional symptoms that were not previously identified (e.g., during an initial generation of a DDL). At block 104, the method adds the additional symptoms to the positive symptom list. At block 106, the processing logic determines whether a threshold has been reached for adding any further pathology. If the threshold to add more diseases to the DDL has not yet been met, the method continues to block 116, at which the new additional symptoms are added to the positive symptom list. If the threshold has been reached, the method proceeds to block 108.

At block 116, the processing logic searches a master pathway symptom elements database 46 for all pathways and elements containing the additional symptom(s). At block 118, the processing logic adds any pathways and elements found to be associated with the symptoms(s) to the possible pathways & elements list 48. The method then proceeds to block 120.

At block 108, pathways identified for diseases already on the DDL are identified in part from a possible pathways and elements list 48. The master pathway symptom elements database 46 is searched for the elements associated with the new symptoms at block 110, and those elements belonging to the previously identified pathways are identified at block 112. At block 114, the processing logic adds the respective elements to the possible pathways & elements list 48. The method then continues to block 150.

Once the possible pathways & elements list has been updated through either blocks 114 or 118, then the relative probability score for each causal element is calculated by the processing logic at block 120 and the method proceeds to FIG. 2B, block 122.

At FIG. 2B, block 122, the processing logic checks causal elements to see if any are associated with multiple symptoms. If any causal elements are associated with multiple symptoms, then elements are ranked by their relative probability score at block 124, and those with the highest score have the associated symptoms identified at block 126. At block 128, the processing logic determines whether the user possesses a next symptom. If so, then the method returns to FIG. 2A, block 104, and the subsequent operations are repeated. If not, then at block 130 the processing logic adds the symptom to a negative symptoms list. The method then returns to block 122. If at block 122 the element does not contain multiple symptoms, then each pathway is examined to see if there are any preceding elements at block 132. If there are preceding elements, the method continues to block 134, at which the preceding elements for all pathways on the possible symptom-pathways list are identified. The method then continues to block 138.

If there are no preceding elements at block 132, the method continues to block 136, at which the processing logic checks for succeeding elements. If at block 136 any succeeding elements are identified, the method continues to block 140, at which the succeeding elements for all pathways on the possible symptom-pathways list are identified. The method then continues to block 138.

At block 138, the processing logic computes relative probability scores for each of the causal elements. The method then continues to block 124.

If at block 136 the patient has no more causal elements along any pathways, then the diseases related to the identified pathways are identified at block 142 and are added to a DDL 50. The method then continues to block 144. At block 144, if the patient has any further symptoms, then the method returns to FIG. 2A, block 102, and the subsequent operations are repeated. If at block 144 it is determined that the patient has no further symptoms, then the DDL is rendered at block 146 in terms of pathways using the pathways & elements list 48.

Referring now to the disclosure in more detail, in FIG. 3 is shown an example of one method 300 of construction of pathologic pathways for diseases in the DDL using individual elements as units of pathology. In some embodiments, this rendering does not follow any predetermined pathways in any related database and is simply based on the information gathered in previous methods described herein and labeled FIGS. 1A and 1B and FIGS. 2A and 2B. In this embodiment, to initiate this constructive rendering, the processing logic accesses possible pathways & elements list 48 and identifies the first or next element on the list at block 202.

At block 204, the processing logic identifies the pathway of the element under examination and at block 206 examines the possible pathways & elements 48 to see if it contains any other elements from the identified pathway. If no other element is found, then at block 208 that element is the sole representation from that pathway. Otherwise, if more elements from that pathway are found then at block 210 the processing logic identifies the next element in the pathway order and at block 212 places elements on a graphical display in order of appearance along their respective pathway. Alternatively, the elements may not be graphically displayed.

At block 214, processing logic identifies the first or next pair of adjacent elements in the order. At block 216, the processing logic examines the identified pair of adjacent elements to see if there are any intervening elements between them when compared to the representation of that same pathway in the master pathway symptom elements database 46. If there are no intervening elements, then at block 222 the processing logic identifies a direct relationship between the pair of adjacent elements. This may be signified by a single arrow. If there are one or more intervening elements, then at block 218 the processing logic determines that there are missing elements from the pathway. Processing logic may signify the relationship between the pair of adjacent elements with multiple-arrows to indicate the lack of a number of elements in the pathway. At block 220, if there are still more elements in the pathway being examined then the processing logic returns to block 214 and an additional pair of adjacent elements is identified. The subsequent steps may then be performed to examine the additional element pair to see if they have any intervening elements at block 216 for representing the relationship through arrows at blocks 218 and 222.

At block 220, if there are no more elements in the pathway, then the method continues to block 224. At block 224, the processing logic determines whether there exists any additional elements in the possible pathways and elements list. If there are no additional elements, then at block 226 the building of pathways is complete. If there are additional elements, then at block 228 the processing logic prepares a new area on the display for a representation of a next pathway, and the process continues to block 202.

Referring now to the disclosure in more detail, in FIG. 4 there is shown an example of a method 400 to render the DDL 50 through contextualizing identified elements within existing pathways. At block 302, the processing logic identifies the first pathway on the DDL, and then at block 304 identifies all elements related to this pathway on the Possible Pathways & Elements list 48.

In some embodiments, the entire pathway is rendered at block 306 in a single color and/or background for all elements included on the Possible Pathways & Elements list 48 and a different font color or background for all other elements in pathway that can be found on the Master Pathway Symptom Elements database 46 but not in the Possible Pathways & Elements list 48. Alternatively other differentiating graphical features such as shapes, textures, icons, fonts, and so forth may be used. If there are any more pathways that can be derived at block 308 from the DDL 50, then at block 312 the processing logic presents the additional pathways in a new section of the display and the method continues to block 302. At block 308, if no additional pathways are on the DDL, then at block 310 the contextualized rendering is complete.

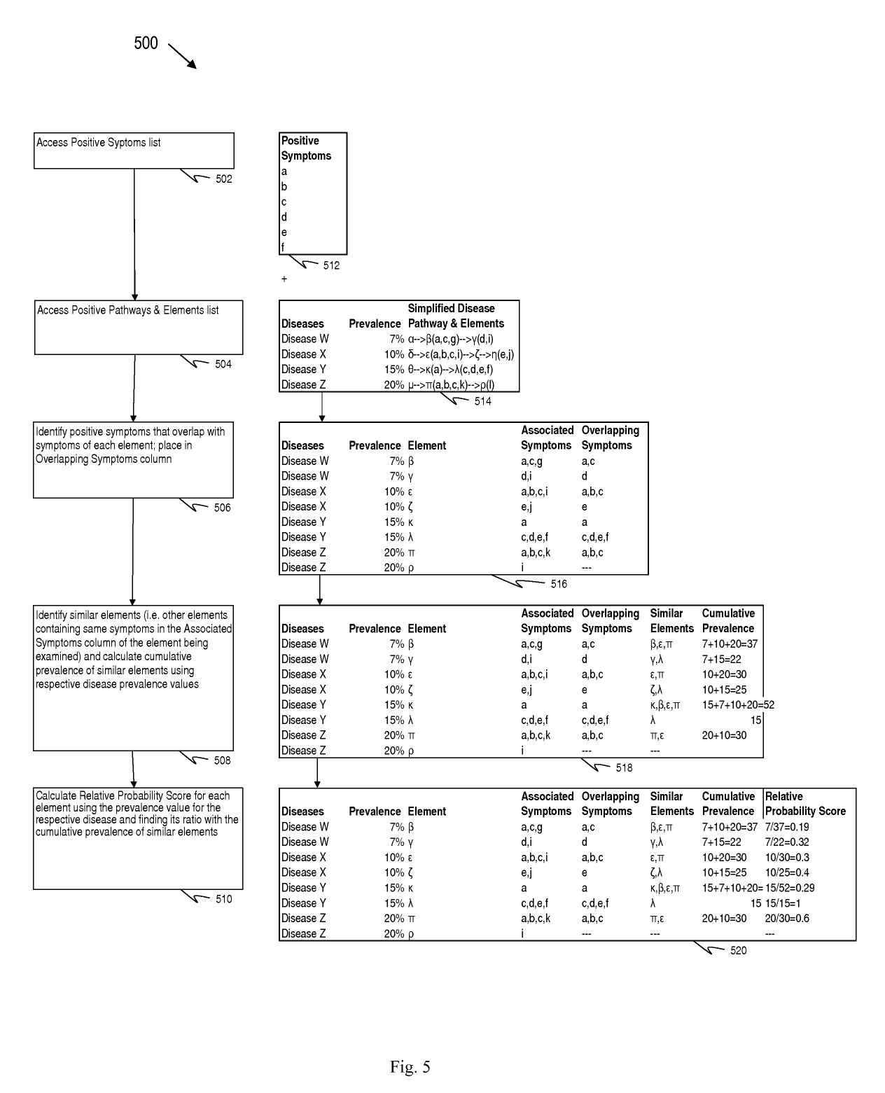

Referring now to the disclosure in more detail, in FIG. 5 there is shown an example of a method 500 for determining the Relative Probability Score for elements. At block 502, the processing logic accesses the Positive Symptoms list. In an example, the Positive Symptoms list have symptoms of ‘a’, ‘b’, ‘c’, ‘d’, ‘e’, and ‘f’, as shown in block 512. At block 504, the processing logic includes this information with information from the Possible Pathways & Elements list and accesses the pathways and respective elements. In our example, pathway elements from all disease pathways which include the identified symptoms are: α, β, γ, ε, ζ, κ, λ, π, ρ, as shown at block 514. Processing logic identifies four possible diseases having the identified positive symptoms. As shown, a first simplified disease pathway for disease W is α→β→γ, where element β has symptoms a, c and g and element γ has symptoms d and j. The first disease W is shown to have a prevalence of 7%. The second simplified disease pathway for disease X is δ→ε→ζ→η, where element c has symptoms a, b, c, and i and element η has symptoms e and j. The third simplified disease pathway for disease Y is θ→κ→λ, where element κ has symptom a and element λ has symptoms c, d, e, and f. The fourth simplified disease pathway for disease Z is μ→π→ρ, where element π has symptoms a, b, c, and k, and element ρ has symptom l. As discussed above, the prevalence of a disease may be in view of either a time period, a specific population, or a geographic location.

At block 506, the processing logic identifies positive symptoms exhibited by a patient that overlap with symptoms of each element. In the example at block 516, the identified overlaps are placed in an Overlapping Symptoms column. As shown in this example, element β of disease W has associated symptoms of a, c and g. Of these associated symptoms, symptoms a and c overlap with symptoms exhibited by the patient. Also as shown in this example, element γ of disease W has associated symptoms d and i, of which symptom d overlaps with the symptom exhibited by the patient.

At block 508, the processing logic identifies similar elements to the identified elements. A similar element may be identified by comparing overlapping symptoms of a first element to the associated symptoms and/or overlapping symptoms of other elements. For example, element β has overlapping symptoms of a and c, and elements c and it also have symptoms of a and c. Accordingly, elements β, ε and π may be placed on the similar elements field for element β of disease W. At blocks 508 and 516, the processing logic notes the respective prevalence values for each element (being the prevalence of the associated disease) and determines a prevalence for each respective element. This is accomplished by adding the prevalence scores of the elements from the similar elements column or field. For example, element β has a prevalence of 7%, element ε has a prevalence of 10% and element π has a prevalence of 20%. Accordingly, the prevalence for element β is 37%.

At blocks 510 and 518, the processing logic calculates the ratio of the prevalence values for each element and the cumulative prevalence found above, with the result being the Relative Probability Score for each element. The relative probability score for an element may be computed by dividing the prevalence value for a particular element by the cumulative prevalence for the elements. For example, the relative probability of β is 7/37=0.19.

The advantages of the present disclosure include, but are not limited to, its ability to use the natural progression of a disease to formulate a list of possible diseases responsible for a user's condition. The system in embodiments has the ability to intelligently convey this information to experienced clinicians regarding disease cause. However, since new diseases may be encountered or a disease entity may not be included in the database, then this system can still display disease processes as they are occurring in the patient so that pathologic processes can be visualized and appropriate investigations formulated. In broad embodiments, the present disclosure provides a computer implemented method to formulate a list of diseases based on disease mechanisms and progression.

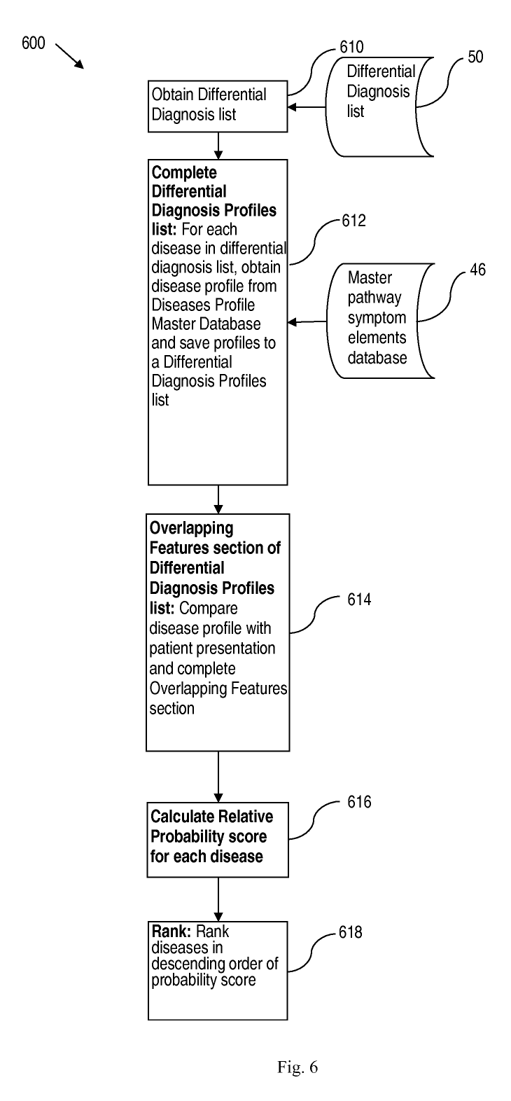

Referring now to the disclosure in more detail, in FIG. 6 there is shown an example of a method 600 and system through which a list of possible diseases explaining the user's condition (called the DDL) is processed to rank each disease in order of its Relative Probability Score given the user's symptoms, exam or other clinical information. Methods discussed herein may be performed on a computer such as a server and results and outcomes from these methods may be displayed on the screen of a user's client device such as a computer, laptop, smartphone, tablet, etc.

In this example shown by FIG. 6, first at block 610, the processing logic identifies the DDL containing a list of possible conditions that explain the patient's presentation. Next, as shown at block 612, the processing logic accesses the master pathway symptom elements database 46 and extracts the profile of each disease on the DDL. The extracted profiles may be added to a differential diagnosis profiles list. As used herein, the term “diseases profile master database” shall generally mean a collection of data stored on a computer and may include data such as disease name, risk factors, prevalence in the general population, and prevalence in populations with risk factors, symptoms, signs, physical exam findings, laboratory values, imaging findings, and genetic findings. The diseases profile master database may exist as a relational database, a table, a spreadsheet, another database type, an arrangement of flat files, or other arrangement of data. The profile of each disease may be found in a preformed disease profiles master database, which contains disease information such as prevalence, risk factors, symptoms, physical exam findings, laboratory findings, imaging findings and other pertinent clinical information.

As part of a rules engine running on a computer such as a server (sometimes called a “component”), at block 614 the processing logic compares a user's clinical information to the profile of each disease on the DDL. As part of block 614, the comparison identifies those clinical features found to be in common between the user's clinical information and each disease's profile on the DDL. Once the clinical features that overlap between the user's clinical information and each disease on the DDL is identified at block 614, then at block 616 the processing logic calculates a Relative Probability Score and assigns to each disease on the DDL. At block 618, all the diseases on the DDL are ranked, for example, in order of decreasing score with the highest score representing the most likely disease related to the user's unique combination of clinical features.

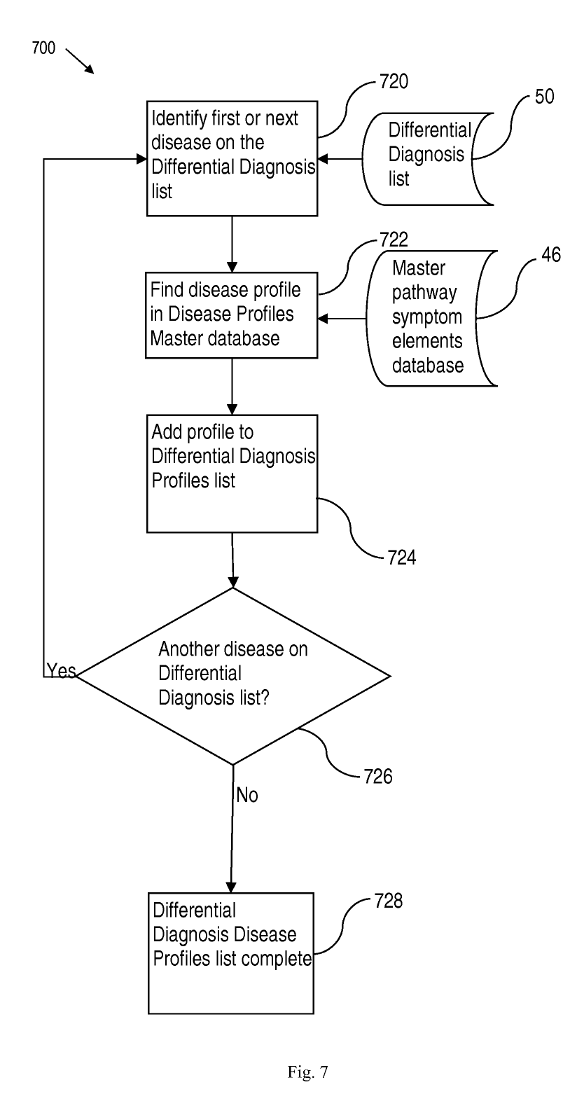

Referring now to the disclosure in more detail, FIG. 7 is an example of a method 700, in which a module extracts the profile of each disease on a DDL from the disease profile master database. In some embodiments, this process is conducted through accessing the DDL 50 after which at block 720 the processing logic identifies the first disease on the DDL. At block 722, the processing logic searches the Diseases Profile Master Database for that disease entry through the Master pathway symptom elements database 46, and when found at block 724 saves it into a Differential Diagnosis Profiles list.

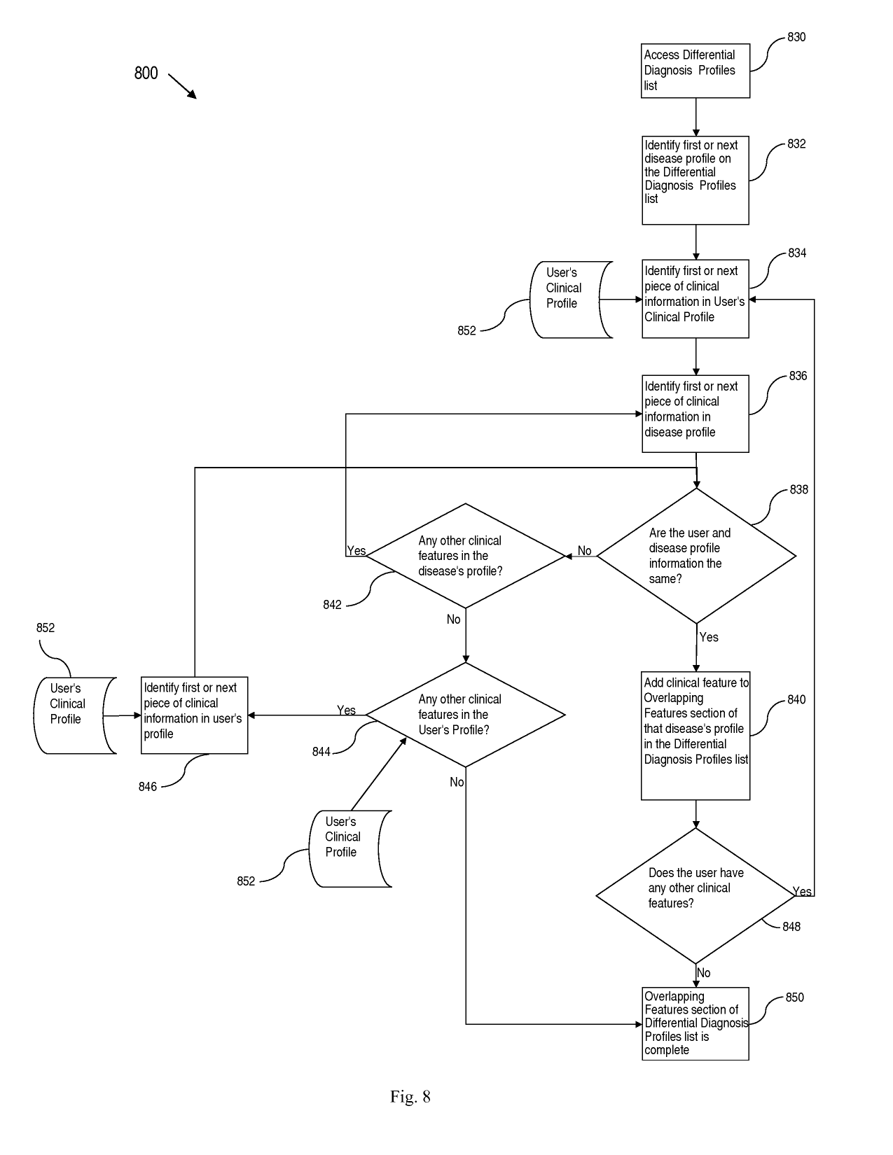

At block 726 the processing logic checks the DDL to see if there are any further diseases that have not yet had their profiles accessed from the Diseases Profile Master Database. If there are still diseases remaining on the DDL that have not yet had their profiles accessed from the Diseases Profile Master Database, then the method reverts to block 720 to identify the next disease on the DDL and at block 722 that search takes place and the respective disease profile is saved. However, if all diseases on the DDL already have had their disease profiles accessed and saved to the Differential Diagnosis Profiles list at block 724, then the differential diagnosis disease profiles list is complete at block 728. The features of each disease on that list (being all the diseases from the DDL) are then compared to see to what extent the user's clinical features overlap with the features of each disease, as shown in FIG. 8. As used herein, the term “differential diagnosis disease profiles list” shall generally mean a list or collection of data stored in a database (or other data structure) and may include data such as diseases listed in the DDL with the information (such as risk factors, prevalence, symptoms, etc.) regarding each respective disease gathered from the diseases profile master database.

Referring now to the disclosure in more detail, FIG. 8 is an example of a method 800 shown as block 614 from FIG. 6, which is an example of the method to compare the user's clinical features with the clinical features of each disease given in their respective disease profiles. At block 830, the processing logic accesses the completed differential diagnosis disease profiles list, which is a list comprising the DDL and the respective clinical features of each of those diseases. In some embodiments, at block 832, the processing logic identifies the first disease profile. At block 834, the processing logic identifies a piece of the user's clinical information in the disease profile, which at block 852 can be found pre-saved in a user's clinical profile. As used herein, the term “user's clinical profile” shall generally mean a list or collection of data stored in a database or other data structure, and may include data such as user age, ethnicity, gender, history of present illness, past medical history, medication use history, surgical history, social history, history of allergies, family history, social history, information from their medical records, symptoms, signs, laboratory findings, imaging findings, and genome studies.

At block 836, the processing logic identifies the first clinical feature in the disease profile accessed in block 832, and at block 838 compares it to the user's first clinical feature identified in block 834 to see if they are the same. If at block 838 they are the same, then at block 840 the processing logic saves this clinical feature, which is overlapping between the user's clinical profile 852 and the disease profile. Processing logic may also save the disease profile being considered to an overlapping features column or field of the differential diagnosis disease profiles list. Processing logic then continues to block 848.

At block 848, processing logic determines whether the user has any other clinical features. If so, the method returns to block 834. Otherwise, the method proceeds to block 850.

If at block 838 the user's clinical feature and the first clinical feature of the disease profile being examined are different, then the method proceeds to block 842. At block 842, the processing logic checks the disease profile to see if it has another clinical feature. If the disease profile does have an additional clinical feature, then at block 836 the processing logic identifies the next clinical feature of the disease profile, and at block 838 examines for overlap with the user's clinical feature of the user's clinical profile. However, if there are no further clinical features in the disease profile at block 842, then the method continues to block 844, at which processing logic checks the user's profile 852 to see if it has any further clinical features.

If at block 844 processing logic determines that the user's profile 852 has an additional clinical feature, then at block 846 the processing logic identifies this next piece of clinical information. Processing logic then compares it with the clinical feature of the disease at block 838 and checks for an overlap. However, if there are no further clinical features in the disease's profile at block 842, and no further clinical features in the user's profile 852 as checked at block 844, then at block 850 the overlapping features section of the differential diagnosis disease profiles list is complete. In one embodiment, this completed section of overlapping features on the differential diagnosis disease profiles list at block 850 is simply the DDL with a column for the clinical features of each respective disease and another column identifying the clinical features of the disease that overlap with the user's clinical features termed.

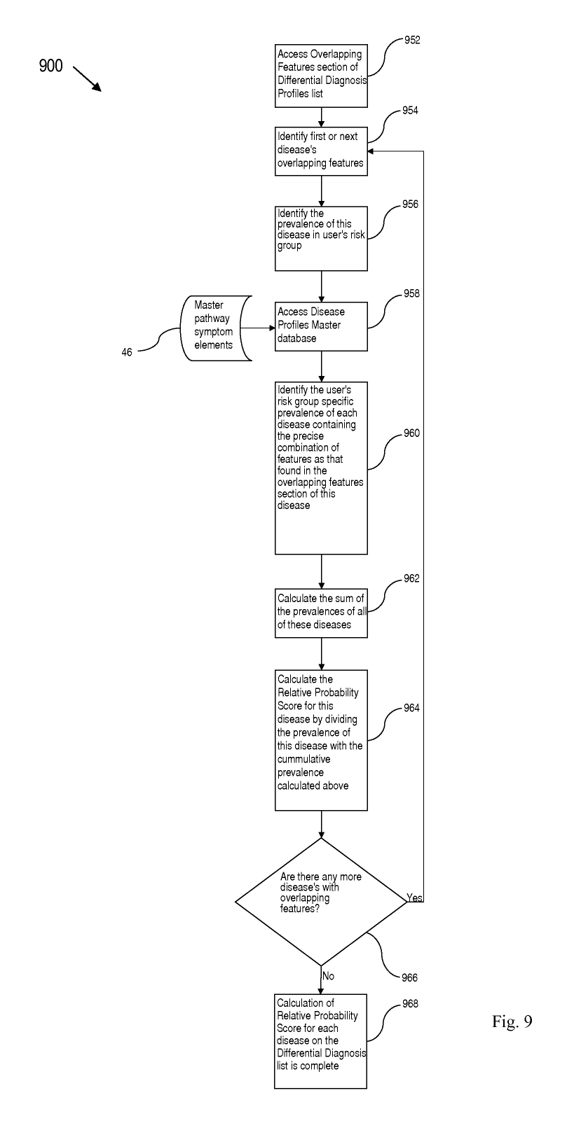

Referring now to the disclosure in more detail, in FIG. 9 there is shown an example of a method 900 as first shown as block 616 from FIG. 6, for example a module to assign relative probability scores to each disease. In terms of calculations this reduces to the following example equation: the relative probability score for disease x=(prevalence of disease x)/(cumulative prevalence of all diseases having the symptoms that overlap between disease x and the user).

In terms of components, the first step in FIG. 9 refers to block 952, in which the processing logic accesses the overlapping features section of the differential diagnosis disease profiles list. In this exemplary embodiment, at block 954 the processing logic identifies the first disease on this list and notes the features in the overlapping features section. At block 956, the processing logic identifies the prevalence of this disease. At block 958, the processing logic accesses the disease profiles master database to acquire master pathway symptom elements 46 for the disease. At block 960, the processing logic searches and identifies the prevalence of diseases that can contain the same combination of symptoms as that found in the overlapping features section of the differential diagnosis disease profiles list. Processing logic may search and identify the prevalence of diseases for the general population, or for a particular patient. The prevalence for a particular patient may be determined based on demographic information about the patient. For example, information such as gender, race, age, drug use, alcohol consumption levels, whether or not a smoker, weight, and so on may be used to identify prevalence information for a particular patient. Each different piece of demographic information may be used to select a particular risk group associated with that patient. Each risk group may have different prevalence information for different diseases.

At block 962, the processing logic sums together these prevalence values to calculate a cumulative prevalence for all of the diseases. At block 964 processing logic then calculates a relative probability score for the disease by dividing the prevalence of the disease by the cumulative prevalence computed at block 962. Accordingly, processing logic calculates a ratio between the prevalence of the disease being identified at block 964 and the cumulative prevalence found in block 962, with the result being the relative probability score at block 964.

At block 966, the processing logic examines the differential diagnosis disease profiles list to see if there are any other diseases with overlapping features as indicated in the overlapping features section. If there are more such diseases, then the method returns to block 964, at which processing logic identifies one such disease. Then, processing logic identifies that disease's prevalence at block 956, and then sums the prevalence of diseases with the combination of diseases as found in the disease's overlapping features (at blocks 954, 956, 958, 960, 962) and at block 964 calculates a relative probability score for that disease. If there are no more diseases on the differential diagnosis disease profiles list then the calculation of the relative probability score is complete at block 968.

Referring now to the disclosure in more detail, in FIG. 10 there is shown an example 1000, which starts with a DDL 1002 and leads to the assignment of relative probability scores 1010. At block 1002 a DDL is identified that includes Disease 1 through Disease 5. At block 1004, the synthesis of the DDL 1002 is shown with the profile of each disease. In this non-limiting example, the disease profile data fields in the DDL are prevalence, risk factors, symptoms, physical exam findings, laboratory values and imaging findings. This example is associated with block 956 of FIG. 9.

At block 1006, processing logic compares the clinical findings in the disease profile of each disease to clinical findings of a user as identified in the user's clinical profile. Clinical findings included in the example clinical profile include age, gender and symptoms. As shown, no past medical history, physical exam findings or laboratory values are included in this user's clinical profile, though this information could be included in other examples.

At block 1008, processing logic identifies those features that are overlapping between the diseases in the DDL and the user's clinical profile. This example is associated with blocks 954 and 960 of FIG. 9.

At block 1010, processing logic uses these overlapping features to formulate the relative probability scores. This example is associated with blocks 962, 964, and 968 of FIG. 9.

The advantages of the present disclosure include, but are not limited to, its ability to answer the question of the conditional probability of a disease given any combination of symptoms. Because patients can present any combination of symptoms, then embodiments may be able to relate the particular combination of symptoms of that patient to the probability that the patient has a particular disease. But since the probabilities of diseases given a large amount of symptom combinations is not practical to assess, then embodiments allow the computationally aided calculation of a probability score for each disease which approximates the conditional probability for any unique symptom combination. Furthermore, embodiments provide methods that can be utilized by computers to allow the ranking of diseases by their probability score, allowing a more accurate identification of pathology than if done by other methods such as symptom matching or prevalence values alone. Embodiments of the present disclosure include a computer implemented method to rank diseases by a score which represents the probability of a particular disease in that person given a combination of clinical features.

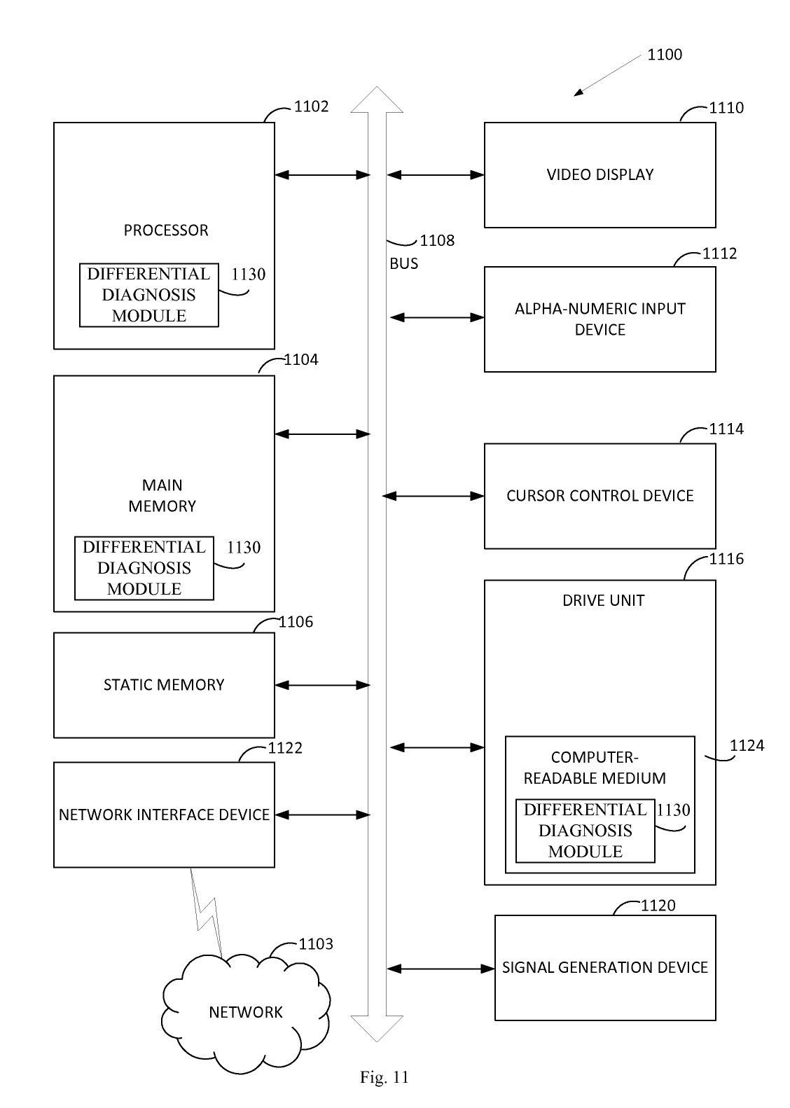

FIG. 11 illustrates a diagrammatic representation of a machine in the exemplary form of a computer system 1100 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1100 includes a processing device (processor) 1102, a main memory 1104 (e.g., read-only memory (ROM), flash memory, dynamic random access memory (DRAM) such as synchronous DRAM (SDRAM) or Rambus DRAM (RDRAM), etc.), a static memory 1106 (e.g., flash memory, static random access memory (SRAM), etc.), and a data storage device 1118, which communicate with each other via a bus 1108.

Processing device 1102 represents one or more general-purpose processing devices such as a microprocessor, central processing unit, or the like. More particularly, the processing device 1102 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1102 may also be one or more special-purpose processing devices such as an application specific integrated circuit (ASIC), a field programmable gate array (FPGA), a digital signal processor (DSP), network processor, or the like. The processing device 1102 is configured to execute instructions 1126 for performing the operations and steps discussed herein.

The computer system 1100 may further include a network interface device 1122. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), and a signal generation device 1120 (e.g., a speaker).

The data storage device 1118 may include a computer-readable storage medium 1124 on which is stored one or more sets of instructions (e.g., Differential Diagnosis Module 1130) embodying any one or more of the methodologies or functions described herein. The Differential Diagnosis Module 1130 may also reside, completely or at least partially, within the main memory 1104 and/or within the processing device 1102 during execution thereof by the computer system 1100, the main memory 1104 and the processing device 1102 also constituting computer-readable storage media. The instructions 1130 may further be transmitted or received over a network 1103 via the network interface device 1122.

While the computer-readable storage medium 1124 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that these and similar terms are to be associated with the appropriate physical quantities and are merely convenient labels applied to these quantities. Unless specifically stated otherwise as apparent from the following discussion, it is appreciated that throughout the description, discussions utilizing terms such as “sending”, “receiving”, “determining”, “displaying”, “obtaining”, “selecting”, “delivering”, “performing”, “generating”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

While the foregoing written description of the disclosure enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

What is claimed is:

1. A method comprising:
receiving, by a processing device, one or more symptoms of a patient;
determining a set of diseases having at least one clinical feature that overlaps with the one or more symptoms of the patient;
determining, for each disease of the set of diseases, a prevalence ratio for the disease, the prevalence ratio comprising a ratio of a prevalence for the disease to a cumulative prevalence of the set of diseases;
determining, by the processing device, for each disease of the set of diseases, a disease relative probability score for the disease in view of the prevalence ratio for the disease;
determining a ranking of the diseases in the set of diseases in view of the disease relative probability scores; and
outputting the ranking of the diseases.

2. The method of claim 1, further comprising:
identifying one or more disease pathways based on the one or more symptoms of the patient;
identifying a plurality of etiologic elements for the one or more symptoms of the patient within each of the respective disease pathways;
determining, for each etiologic element, a prevalence ratio for the etiologic element, the prevalence ratio comprising a ratio of a prevalence for the etiologic element to a cumulative prevalence of the plurality of etiologic elements;
determining, by the processing device, for each etiologic element of the plurality of etiologic elements, an element relative probability score for the etiologic element in view of the prevalence ratio for the etiologic element;
determining a further symptom of the patient based on the element relative probability score and based on the identified disease pathways;
identifying at least one disease in view of the one or more disease pathways and the further symptom; and
constructing a new disease pathway for the patient based on the at least one identified disease.

3. The method of claim 2, further comprising:
ranking the etiologic elements in view of the element relative probability scores; and
outputting the ranking of the etiologic elements.

4. The method of claim 1, wherein each respective disease of the set of diseases comprises a disease profile comprising at least one of a risk factor of the respective disease, a prevalence of the respective disease, or a clinical feature of the respective disease.

5. The method of claim 4, wherein the prevalence of the respective disease is in view of at least one of a time period, a specific population, or a geographic location.

6. The method of claim 1, further comprising ranking each respective disease of the set of diseases in view of clinical information of the patient.

7. The method of claim 6, wherein the clinical information of the patient comprises at least one of an age, ethnicity, gender, history of present illness, past medical history, medication use history, surgical history, social history, history of allergies, family history, social history, information from medical records, symptoms, laboratory findings, imaging findings, or genome studies of the patient.

8. The method of claim 1, further comprising:
for each respective disease of the set of diseases, identifying the at least one clinical feature of the respective disease that corresponds to the one or more symptoms of the patient, wherein the disease relative probability score for each respective disease is determined based at least in part on a combination of identified clinical features of the disease that corresponds to the one or more symptoms of the patient.

9. The method of claim 1, wherein the respective disease relative probability score for each disease comprises a value representing a conditional probability of a disease diagnosis for the respective disease.

10. The method of claim 1, further comprising:
computing a prevalence for each disease in the set of diseases.

11. A non-transitory computer readable storage medium having instructions stored thereon that, when executed by a processing device, cause the processing device to execute operations comprising:
receiving, by the processing device, one or more symptoms of a patient;
determining a set of diseases having at least one clinical feature that overlaps with the one or more symptoms of the patient;
determining, for each disease of the set of diseases, a prevalence ratio for the disease, the prevalence ratio comprising a ratio of a prevalence for the disease to a cumulative prevalence of the set of diseases;
determining, by the processing device, for each disease of the set of diseases, a disease relative probability score for the disease in view of the prevalence ratio for the disease;
determining a ranking of the diseases in the set of diseases in view of the disease relative probability scores; and
outputting the ranking of the diseases.

12. The non-transitory computer readable storage medium of claim 11, further comprising:
identifying one or more disease pathways based on the one or more symptoms of the patient;
identifying etiologic elements for the one or more symptoms of the patient within each of the respective disease pathways;
determining, for each etiologic element, a prevalence ratio for the etiologic element, the prevalence ratio comprising a ratio of a prevalence for the etiologic element to a cumulative prevalence of the etiologic elements;
determining, by the processing device, for each etiologic element of the etiologic elements, an element relative probability score for the etiologic element in view of the prevalence ratio for the etiologic element;
determining a further symptom of the patient based on the element relative probability score and based on the identified disease pathways;
identifying at least one disease in view of the one or more disease pathways and the further symptom; and
constructing a new disease pathway for the patient based on the at least one identified disease.

13. The non-transitory computer readable storage medium of claim 11, wherein each respective disease of the set of diseases comprises a disease profile comprising at least one of a risk factor of the respective disease, a prevalence of the respective disease, or a clinical feature of the respective disease.

14. The non-transitory computer readable storage medium of claim 13, wherein the prevalence of the disease is in view of at least one of a time period, a specific population, or a geographic location.

15. The non-transitory computer readable storage medium of claim 11, further comprising ranking each respective disease of the set of diseases in view of clinical information of the patient.

16. A system comprising:
a data store; and
a processing device coupled to the data store, the processing device to:
receive one or more symptoms of a patient,
determine a set of diseases having at least one clinical feature that overlaps with the one or more symptoms of the patient,
determine, for each disease of the set of diseases, a prevalence ratio for the disease, the prevalence ratio comprising a ratio of a prevalence for the disease to a cumulative prevalence of the set of diseases,
determine, for each disease of the set of diseases, a disease relative probability score for the disease in view of the prevalence ratio for the disease, determining a ranking of the diseases in the set of diseases in view of the disease relative probability scores, and
output the ranking of the diseases.

17. The system of claim 16, further comprising the processing device to:
identify one or more disease pathways based on the one or more symptoms of the patient;
identify etiologic elements for the one or more symptoms of the patient within each of the respective disease pathways;
determine, for each etiologic element, a prevalence ratio for the etiologic element, the prevalence ratio comprising a ratio of a prevalence for the etiologic element to a cumulative prevalence of the etiologic elements;
determine, for each etiologic element of the etiologic elements, an element relative probability score for the etiologic element in view of the prevalence ratio for the etiologic element;
determine a further symptom of the patient based on the element relative probability score and based on the identified disease pathways;
identify at least one disease in view of the one or more disease pathways and the further symptom; and
construct a new disease pathway for the patient based on the at least one identified disease.

18. The system of claim 16, wherein each respective disease of the set of diseases comprises a disease profile comprising at least one of a risk factor of the respective disease, a prevalence of the respective disease, or a clinical feature of the respective disease.

19. The system of claim 18, wherein the prevalence of the disease is in view of at least one of a time period, a specific population, or a geographic location.

20. The system of claim 16, further comprising rank each respective disease of the set of diseases in view of clinical information of the patient.
